(19) United States
(12) Patent Application Publication
(10) Pub. No.: US 2026/0169507 A1
(43) Pub. Date: Jun. 18, 2026

(54) DIAPHRAGM FOR REGULATING INTERNAL PRESSURE OF TANK AND DIAPHRAGM ASSEMBLY COMPRISING SAME

(71) Applicant: Yoon S OH, Gyeonggi-do (KR)

(72) Inventors: Yoon S OH, Gyeonggi-do (KR); Hun KIM, IRVINE, CA (US)

(21) Appl. No.: 19/307,040

(22) Filed: Aug. 22, 2025

Related U.S. Application Data
(63) Continuation of application No. PCT/KR2025/010067, filed on Jul. 10, 2025.

(30) Foreign Application Priority Data
Dec. 12, 2024 (KR) 10-2024-0184305

(51) Int. Cl. G05D 16/06

(52) U.S. Cl. CPC G05D 16/0644

(57) ABSTRACT

A diaphragm assembly for regulating internal pressure of a tank is disclosed. The assembly includes a diaphragm installed inside the tank and a fixing ring configured to secure the diaphragm. The diaphragm comprises a separation boundary portion separating liquid and gas, a connection portion extending therefrom, a fixing portion bent inward to form a concave shape, and a locking portion that engages an inner surface of the tank. The fixing ring is provided inside the diaphragm and presses the fixing portion for secure attachment. The diaphragm includes a plurality of first outer reinforcement beads extending radially from a center of the separation boundary portion, and a plurality of first inner reinforcement beads provided on an inner surface of the separation boundary portion, spatially overlapping the outer beads. These reinforcement beads distribute stress more evenly and enhance durability by reducing stress concentration caused by internal pressure fluctuations within the tank.

### CROSS-REFERENCE TO RELATED APPLICATION

This application is a US Bypass Continuation Application of International Application No. PCT/KR2025/010067, filed on July 10, 2025, which claims priority to and the benefit of Korean Patent Application No. 10-2024-0184305, filed on December 12, 2024, the disclosure of which is incorporated herein by reference in its entirety.

### BACKGROUND

### Technical Field

The present invention relates to a diaphragm for regulating internal pressure of a tank and a diaphragm assembly including the same.

### Background Art

In water or brine circulation systems such as boilers or chillers, repeated expansion and contraction of liquid volume may occur due to changes in the liquid temperature, which may lead to pressure fluctuations within the system. If such pressure fluctuations are left unaddressed, problems such as overload on the piping, leakage, damage, or malfunction of the device may arise. To address these issues, a diaphragm may be installed inside a tank, and the diaphragm functions to separate gas and liquid and absorb pressure changes.

However, in conventional diaphragms, when used repeatedly, stress concentration and physical wear may occur in specific regions due to pressure fluctuations, leading to damage and a shortened lifespan. Furthermore, problems such as insufficient coupling between the diaphragm and a fixing ring for fixing the diaphragm to the tank, or physical damage to the diaphragm due to friction at the coupling region, may also occur.

### SUMMARY

### Technical Problem

The present disclosure aims to solve the aforementioned problems.

More specifically, one object of the present disclosure is to provide a diaphragm with improved durability by preventing stress concentration in specific regions.

Another object of the present disclosure is to provide a diaphragm that maintains a stable coupling state even under repeated pressure changes by ensuring firm engagement with the tank.

A further object of the present disclosure is to provide a diaphragm with improved reliability by preventing physical damage at the coupling region with the fixing ring.

### Technical Solution

In order to achieve the above objectives, a diaphragm assembly for regulating internal pressure of a tank according to an exemplary embodiment of the present disclosure may include: a diaphragm disposed inside the tank, the diaphragm including: a separation boundary portion that separates liquid and gas inside the tank; a connection portion extending in one direction from the separation boundary portion; a fixing portion extending from the connection portion and bent toward an inside of the diaphragm to have a concave shape; and a locking portion extending from the fixing portion, at least a portion of the locking portion being engaged with an inner surface of the tank; and a fixing ring provided inside the diaphragm, the fixing ring being configured to press the fixing portion to fix the diaphragm to the tank; wherein the diaphragm may include: a plurality of first outer reinforcement beads provided on an outer surface of the separation boundary portion and extending in a radial direction from a center of the separation boundary portion; and a plurality of first inner reinforcement beads provided on an inner surface of the separation boundary portion and extending in a radial direction from the center of the separation boundary portion so as to spatially overlap the plurality of first outer reinforcement beads.

In an exemplary embodiment, the diaphragm may further include: a plurality of second outer reinforcement beads provided on the outer surface of the separation boundary portion and extending in a circumferential direction surrounding the center of the separation boundary portion; and a plurality of second inner reinforcement beads provided on the inner surface of the separation boundary portion and extending in a circumferential direction surrounding the center of the separation boundary portion so as to spatially overlap the plurality of second outer reinforcement beads.

In an exemplary embodiment, the plurality of first outer reinforcement beads and the plurality of first inner reinforcement beads extend to the connection portion of the diaphragm.

In an exemplary embodiment, the diaphragm may further include: a curved reinforcement portion protruding from the inner surface of the separation boundary portion, the curved reinforcement portion having a thickness that gradually increases toward the center.

In an exemplary embodiment, the curved reinforcement portion is integrally connected to the plurality of first inner reinforcement beads and a thickness of the curved reinforcement portion is greater than a thickness of the plurality of first inner reinforcement beads.

In an exemplary embodiment, the diaphragm may further include: spacing adjustment portions protruding from the outer surface of the separation boundary portion to form a gap space between a portion of the diaphragm and the tank, the spacing adjustment portions being symmetrically disposed with respect to the center of the separation boundary portion; wherein some of the plurality of first outer reinforcement beads are connected to the spacing adjustment portions, and the other beads of the plurality of first outer reinforcement beads extend between adjacent spacing adjustment portions.

In an exemplary embodiment, the diaphragm may further include: a first support protrusion protruding toward the inside of the diaphragm from a first support region of the fixing portion, the first support region being relatively close to the connection portion, and supporting at least a portion of the fixing ring; and a second support protrusion protruding toward the inside of the diaphragm from a second support region of the fixing portion, the second support region being relatively close to the locking portion, and supporting at least a portion of the fixing ring.

In an exemplary embodiment, a protrusion length of the second support protrusion is greater than a protrusion length of the first support protrusion.

In an exemplary embodiment, the fixing ring may include: a first fixing portion having a curved shape and being in contact with the first support protrusion; and a second fixing portion having a curved shape and being in contact with the second support protrusion; and the fixing portion of the diaphragm may include: a first fixing groove having a concave shape for receiving the first fixing portion; and a second fixing groove having a concave shape for receiving the second fixing portion.

In another exemplary embodiment of the present disclosure, there is provided a diaphragm configured to regulate pressure inside a tank, and including a separation boundary portion that separates liquid and gas inside the tank. The diaphragm may include: a plurality of first outer reinforcement beads provided on an outer surface of the separation boundary portion and extending in a radial direction from a center of the separation boundary portion; a plurality of first inner reinforcement beads provided on an inner surface of the separation boundary portion and extending in a radial direction from the center of the separation boundary portion so as to spatially overlap the plurality of first outer reinforcement beads; a plurality of second outer reinforcement beads provided on the outer surface of the separation boundary portion and extending in a circumferential direction surrounding the center of the separation boundary portion; a plurality of second inner reinforcement beads provided on the inner surface of the separation boundary portion and extending in a circumferential direction surrounding the center of the separation boundary portion so as to spatially overlap the plurality of second outer reinforcement beads; and a curved reinforcement portion protruding from the inner surface of the separation boundary portion, the curved reinforcement portion having a thickness that gradually increases toward the center and being integrally connected to the plurality of first inner reinforcement beads.

### Effect of the Invention

The diaphragm of the present disclosure may include a plurality of reinforcement beads protruding in radial and circumferential directions from both an outer surface and an inner surface, thereby preventing stress concentration on a specific portion of the diaphragm and improving durability of the diaphragm.

Additionally, the diaphragm of the present disclosure may include a support protrusion supporting at least a portion of a fixing ring, so that the diaphragm can maintain a stable coupling state with the fixing ring even under repeated pressure fluctuations.

Furthermore, an edge portion of the fixing ring of the present disclosure may be formed as a curved surface, and a portion of the diaphragm accommodating the fixing ring may be provided in a concave shape, thereby preventing physical damage to the diaphragm caused by the fixing ring.

### BRIEF DESCRIPTION OF THE DRAWINGS

FIG. 1 is a perspective view of a diaphragm according to an exemplary embodiment of the present disclosure.

FIG. 2 is a plan view of the diaphragm according to an exemplary embodiment of the present disclosure.

FIG. 3 is a bottom view of the diaphragm according to an exemplary embodiment of the present disclosure.

FIG. 4 is a sectional view showing a cut portion of the diaphragm according to an exemplary embodiment of the present disclosure.

FIG. 5 is a view showing a portion of the diaphragm installed in a tank according to an exemplary embodiment of the present disclosure.

FIG. 6 is an enlarged view of a region marked as A in FIG. 1.

FIG. 7 is a view showing a fixing ring according to an exemplary embodiment of the present disclosure.

FIG. 8 is a view showing a coupling relationship between a diaphragm and a fixing ring according to a comparative example.

FIG. 9 is a view showing a coupling relationship between a diaphragm and a fixing ring according to an exemplary embodiment of the present disclosure.

FIG. 10 is a view showing a diaphragm assembly coupled to a tank according to an exemplary embodiment of the present disclosure.

### DETAILED DESCRIPTION

Hereinafter, preferred embodiments of the present disclosure will be described in detail with reference to the accompanying drawings. Advantages, features, and methods of achieving the present disclosure will become apparent from the embodiments described in detail below with reference to the drawings. However, the technical spirit of the present disclosure is not limited to the embodiments described below and may be implemented in various other forms. The following embodiments are merely provided to fully convey the technical spirit of the present disclosure and to enable those skilled in the art to fully understand the scope of the present disclosure. The technical spirit of the present disclosure is defined only by the scope of the claims.

In the drawings, it should be noted that the same reference numerals are assigned to like elements, even though they are shown in different drawings, as much as possible. Also, in describing the present disclosure, a detailed description of related known components or functions will be omitted if it is determined that such a description would obscure the gist of the present disclosure.

Unless otherwise defined, all terms (including technical and scientific terms) used in this specification have the same meanings commonly understood by those skilled in the art to which the present disclosure pertains. Terms defined in commonly used dictionaries are to be interpreted as having meanings consistent with their ordinary usage, unless clearly and specifically defined otherwise. The terminology used herein is for the purpose of describing particular embodiments only and is not intended to limit the scope of the present disclosure. As used herein, the singular forms also include the plural forms unless otherwise specified.

In describing the components of the present disclosure, terms such as first, second, A, B, (a), (b), etc., may be used. These terms are merely for distinguishing one element from another and do not limit the nature, order, or sequence of the elements. When a certain component is described as being “connected,” “coupled,” or “joined” to another component, it should be understood that the component may be directly connected or coupled to the other component, or one or more intervening components may be present between them.

The terms “comprises” and/or “comprising,” as used herein, do not exclude the presence or addition of one or more other components, steps, operations, and/or elements.

The components included in one embodiment and having common functions may be described using the same terminology in other embodiments. Unless otherwise stated, the descriptions provided in one embodiment may be applicable to other embodiments as well, and specific descriptions that are redundant or obvious to those skilled in the art may be omitted.

Hereinafter, the present invention will be described in detail with reference to preferred embodiments and the accompanying drawings.

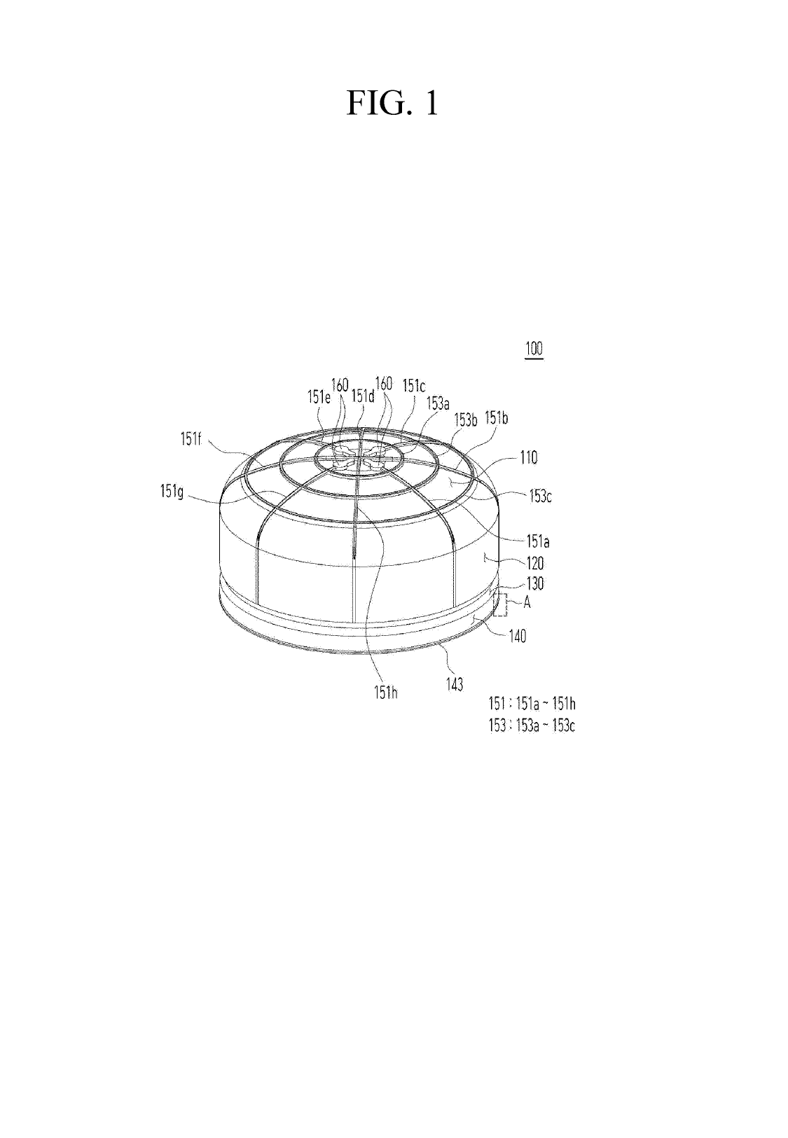

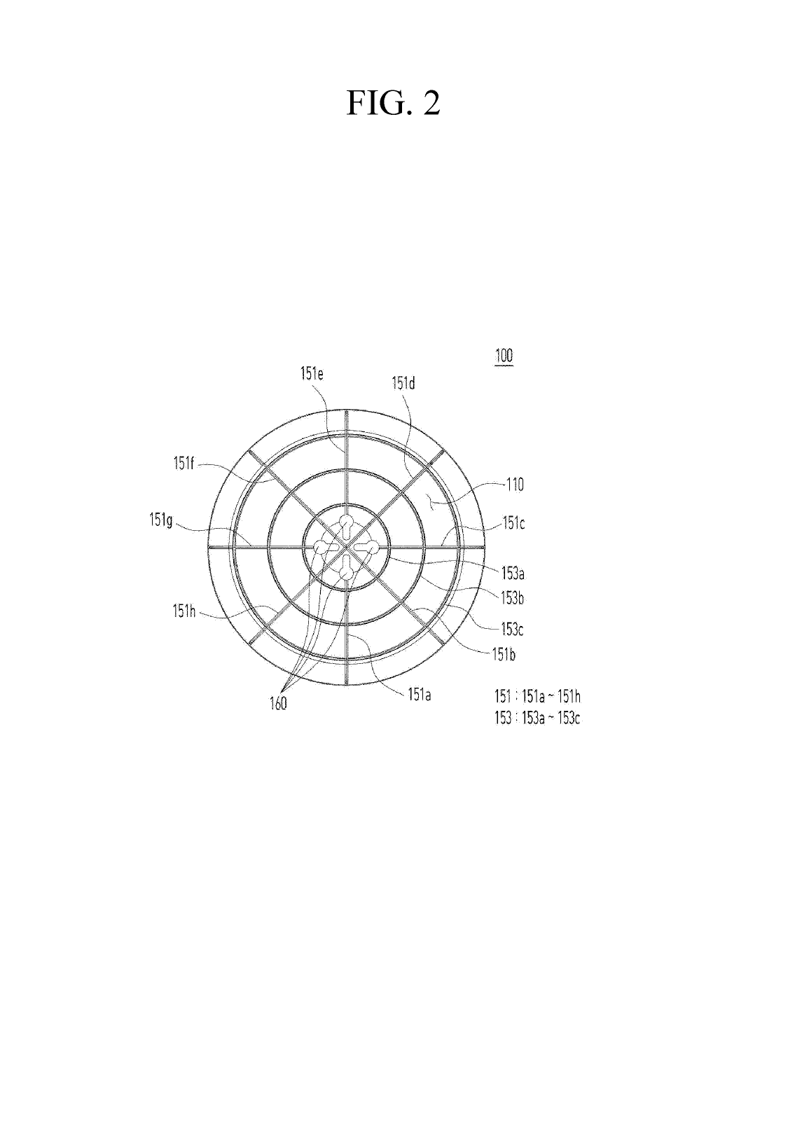

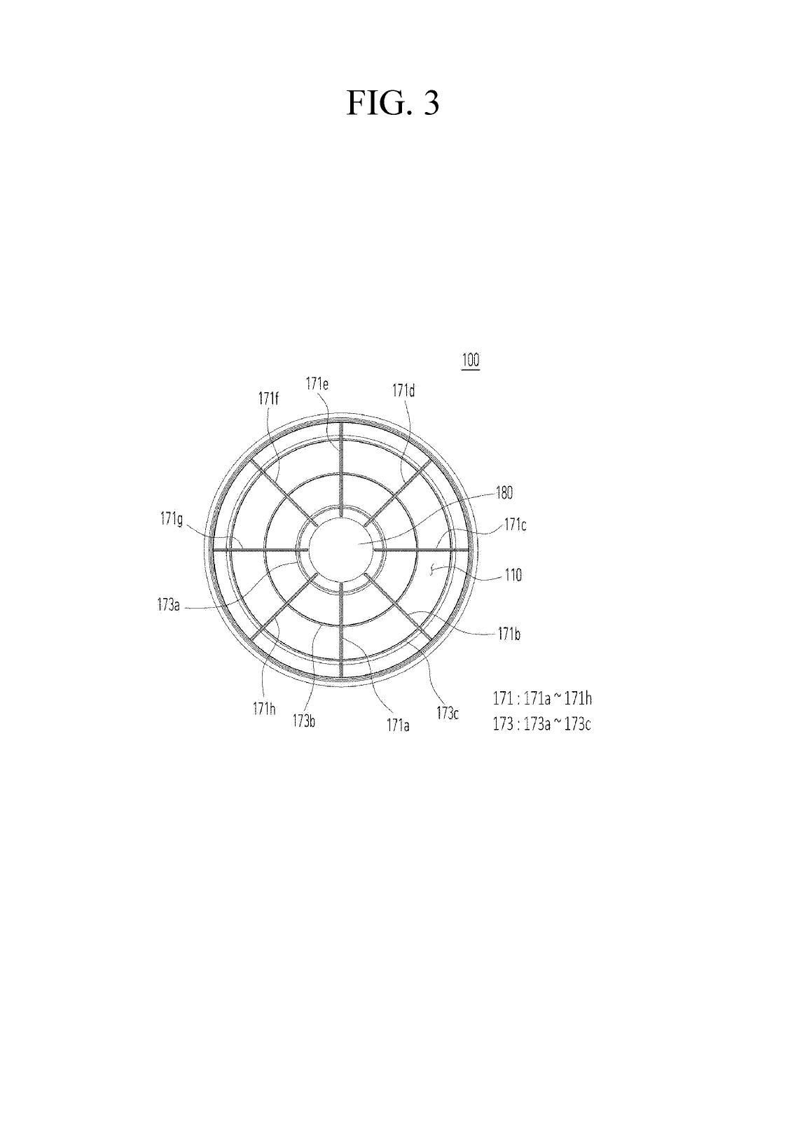

FIG. 1 is a perspective view of a diaphragm 100 according to an exemplary embodiment of the present disclosure. FIG. 2 is a plan view of the diaphragm 100 according to an exemplary embodiment of the present disclosure. FIG. 3 is a bottom view of the diaphragm 100 according to an exemplary embodiment of the present disclosure.

Hereinafter, the diaphragm 100 of the present disclosure will be described in more detail with reference to FIGS. 1 to 3.

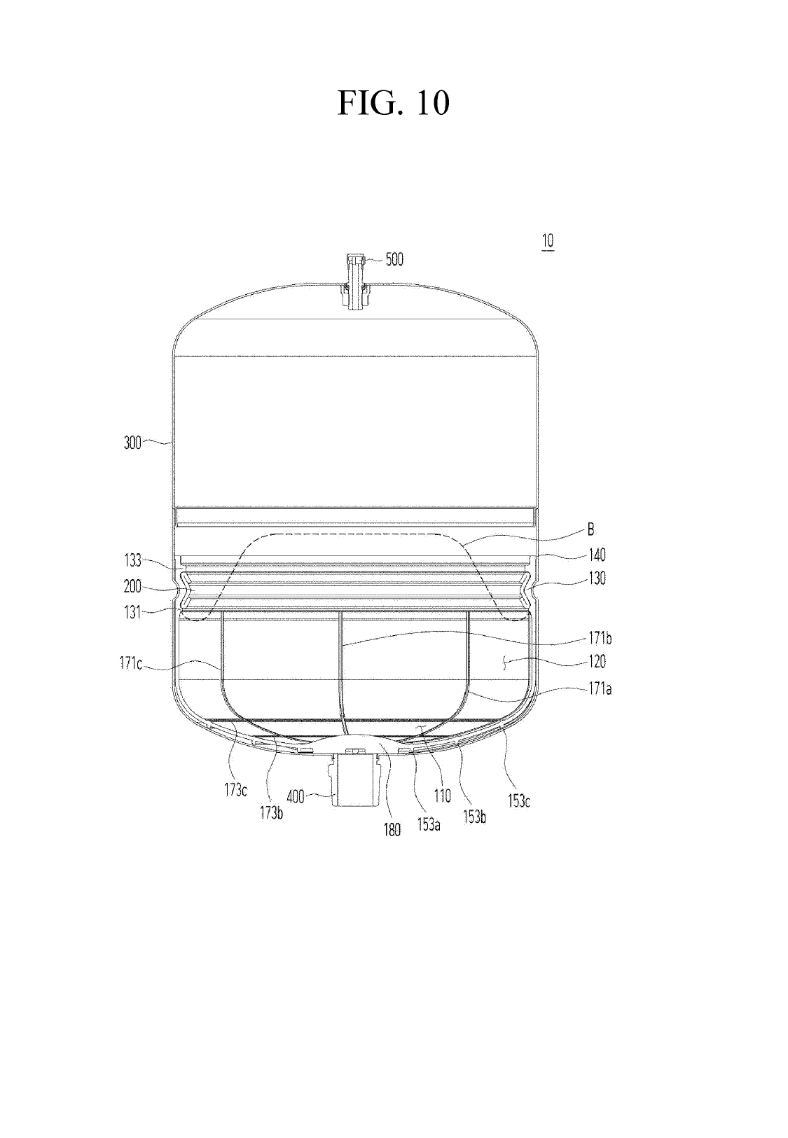

The diaphragm 100 of the present disclosure may be installed inside a tank (see FIG. 10, 300) to separate liquid and gas, and may be configured to regulate pressure variations inside the tank 300. That is, the diaphragm 100 may be configured to efficiently regulate pressure changes caused by changes in the liquid volume resulting from temperature variations inside the tank 300.

Referring collectively to FIGS. 1 to 3, the diaphragm 100 of the present disclosure may be provided in a shape corresponding to a portion of the tank in which the diaphragm 100 is installed. For example, as illustrated in FIG. 1, the diaphragm 100 may be provided in a bowl shape or a hemispherical shape. However, the shape of the diaphragm 100 is not limited thereto and may be provided in various other forms.

The diaphragm 100 may include a separation boundary portion 110 configured to separate liquid and gas inside the tank 300, a connection portion 120 extending in one direction from the separation boundary portion 110, a fixing portion 130 extending from the connection portion 120 and bent toward an inside of the diaphragm 100 to have a concave shape, and a locking portion 140 extending from the fixing portion 130, at least a portion of the locking portion 140 being engaged with an inner surface of the tank 300.

In an exemplary embodiment, the separation boundary portion 110 is a portion of the diaphragm 100 that physically separates liquid and gas inside the tank. The separation boundary portion 110 may be configured to be deformable within the tank in order to absorb pressure variations based on changes in the liquid volume caused by temperature fluctuations.

In an exemplary embodiment, the separation boundary portion 110 may be provided in a curved shape to uniformly distribute pressure and maintain durability. For example, the separation boundary portion 110 may be provided in a dome shape. However, the shape of the separation boundary portion 110 is not limited thereto.

In an exemplary embodiment, the connection portion 120 is a portion of the diaphragm 100 that extends in one direction from the separation boundary portion 110. The one direction may be defined as a direction parallel to an imaginary line passing vertically through a central portion of the separation boundary portion 110. In an exemplary embodiment, the connection portion 120 may connect the separation boundary portion 110 and a fixing portion 130, which will be described below.

In an exemplary embodiment, the fixing portion 130 may extend from the connection portion 120 and be bent toward an inside of the diaphragm 100 to have a concave shape.

The fixing portion 130 may be a portion of the diaphragm 100 that is coupled to the tank by a fixing ring 200, which will be described below. Accordingly, the separation boundary portion 110 and the connection portion 120 of the diaphragm 100 may move upward and downward relative to the fixing portion 130 based on pressure fluctuations.

In an exemplary embodiment, the locking portion 140 may extend from the fixing portion 130 such that at least a portion the locking portion 140 is engaged with an inner surface of the tank. Specifically, the locking portion 140 may include a locking protrusion 143 formed on an outer surface of the diaphragm 100. Since the diaphragm 100 of the present disclosure may include the locking protrusion 143, the diaphragm 100 can be firmly coupled to the tank.

The separation boundary portion 110 and the connection portion 120 of the diaphragm 100 preferably remain free to move inside the tank, so that a sticking phenomenon to the tank is prevented. In contrast, the fixing portion 130 and the locking portion 140 of the diaphragm 100 are preferably fixed firmly to the inner surface of the tank to allow the separation boundary portion 110 and the connection portion 120 to move freely.

Since the diaphragm 100 of the present disclosure may include the locking protrusion 143, the fixing portion 130 and the locking portion 140 of the diaphragm 100 can be firmly coupled to the inner surface of the tank, while the separation boundary portion 110 and the connection portion 120 are allowed to move freely inside the tank.

The diaphragm 100 of the present disclosure may include a plurality of first outer reinforcement beads 151 provided on an outer surface of the separation boundary portion 110 and extending in a radial direction from a center of the separation boundary portion 110. The radial direction may be defined as a direction away from the center of the separation boundary portion 110.

In an exemplary embodiment, the plurality of first outer reinforcement beads 151 may be symmetrically arranged with respect to the center of the separation boundary portion 110. For example, as shown in FIG. 2, when the plurality of first outer reinforcement beads 151 is provided as eight first outer reinforcement beads, the eight first outer reinforcement beads 151a to 151h may be arranged at 45-degree intervals in a symmetrical manner. However, the number and arrangement of the plurality of first outer reinforcement beads 151 are not limited thereto.

In an exemplary embodiment, the plurality of first outer reinforcement beads 151 may be integrally formed with the separation boundary portion 110. Specifically, the plurality of first outer reinforcement beads 151 and the separation boundary portion 110 may be formed of the same material (e.g., rubber) and may be integrated with each other.

In an exemplary embodiment, some of the plurality of first outer reinforcement beads 151 (e.g., 151a, 151c, 151e, and 151g) may be connected to spacing adjustment portions 160, which will be described below. In addition, the other beads among the plurality of first outer reinforcement beads 151 (e.g., 151b, 151d, 151f, and 151h) may extend in the radial direction between adjacent spacing adjustment portions 160.

For example, some beads (e.g., 151a, 151c, 151e, and 151g) may be connected to the spacing adjustment portions 160 and may not be interconnected with opposing first outer reinforcement beads (e.g., 151a and 151e). The other beads (e.g., 151b, 151d, 151f, and 151h) may be interconnected with their respective opposing first outer reinforcement beads (e.g., 151b and 151f), forming an integrated structure.

The plurality of first outer reinforcement beads 151 of the present disclosure may more uniformly distribute repetitive pressure changes or external forces, thereby preventing stress from concentrating on a specific portion of the diaphragm 100. Accordingly, fatigue damage occurring at a specific portion of the diaphragm 100 can be effectively prevented, and physical damage to the diaphragm 100 can be reduced, thereby improving durability of the diaphragm 100.

In addition, the plurality of first outer reinforcement beads 151 of the present disclosure may be provided on an outer surface of the diaphragm 100, thereby reducing the contact area between the tank and the diaphragm 100. As a result, the plurality of first outer reinforcement beads 151 may allow the diaphragm 100 to move freely inside the tank and suppress a sticking phenomenon by reducing the contact area between the diaphragm 100 and the tank.

The sticking phenomenon may refer to a condition in which the diaphragm 100 is excessively adhered to the tank and physically attached thereto. The sticking phenomenon may restrict the normal movement of the diaphragm 100, thereby degrading the pressure regulation function of the diaphragm 100.

In an exemplary embodiment, the plurality of first outer reinforcement beads 151 may extend to the connection portion 120 of the diaphragm 100. That is, the plurality of first outer reinforcement beads 151 may extend to a side portion of the diaphragm 100. Accordingly, the plurality of first outer reinforcement beads 151 may distribute stress not only in a central portion but also in the side portion of the diaphragm 100.

Furthermore, the plurality of first outer reinforcement beads 151 may allow free movement of the side portion of the diaphragm 100, thereby helping the diaphragm 100 to operate stably even under repetitive pressure fluctuations. In addition, the plurality of first outer reinforcement beads 151 may reduce the contact area between the side portion of the diaphragm 100 and the tank, thereby suppressing the aforementioned sticking phenomenon and improving the durability and operational efficiency of the diaphragm 100.

The diaphragm 100 of the present disclosure may include a plurality of first inner reinforcement beads 171 that are provided on an inner surface of the separation boundary portion 110 and extend in a radial direction from a center of the separation boundary portion 110 so as to spatially overlap the plurality of first outer reinforcement beads 151.

In an exemplary embodiment, the plurality of first inner reinforcement beads 171 may be provided symmetrically with respect to the center of the separation boundary portion 110. For example, as illustrated in FIG. 3, when the plurality of first inner reinforcement beads 171 are provided as eight first inner reinforcement beads, the eight first inner reinforcement beads 171a to 171h may be arranged symmetrically at 45-degree intervals. However, the number and arrangement of the plurality of first inner reinforcement beads 171 are not limited thereto.

Hereinafter, redundant descriptions between the plurality of first inner reinforcement beads 171 and the plurality of first outer reinforcement beads 151 will be omitted, and the differences therebetween will be primarily described.

In an exemplary embodiment, the plurality of first inner reinforcement beads 171 and the plurality of first outer reinforcement beads 151 may be spatially overlapped. Specifically, when the diaphragm 100 is viewed in plan, the plurality of first inner reinforcement beads 171 and the plurality of first outer reinforcement beads 151 may be spatially overlapped. This overlapping structure may maximize the combined reinforcement effect between the reinforcement beads formed on the inner surface and the outer surface of the separation boundary portion 110, thereby further enhancing the structural stability of the diaphragm 100.

Due to the overlapping structure, the diaphragm 100 may be designed such that the protrusion length of the plurality of first outer reinforcement beads 151 protruding from the surface of the separation boundary portion 110 is reduced. This design may minimize the influence on fluid flow inside the tank, while alleviating stress concentration that may occur in the diaphragm 100, thereby improving its durability. In addition, the plurality of first inner reinforcement beads 171 and the plurality of first outer reinforcement beads 151 may be provided in substantially similar sizes and shapes.

In addition, the diaphragm 100 of the present disclosure may include a plurality of second outer reinforcement beads 153 that are provided on an outer surface of the separation boundary portion 110 and extend in a circumferential direction surrounding the center of the separation boundary portion 110. The circumferential direction may be defined as a direction surrounding the center of the separation boundary portion 110, and may be perpendicular to the aforementioned radial direction.

In an exemplary embodiment, the plurality of second outer reinforcement beads 153 may be provided in circular shapes of various sizes. For example, as illustrated in FIG. 2, when the plurality of second outer reinforcement beads 153 is provided as three second outer reinforcement beads, the three second outer reinforcement beads 153a to 153c may be arranged in circular shapes surrounding each other. However, the number and arrangement of the plurality of second outer reinforcement beads 153 are not limited thereto.

In an exemplary embodiment, the plurality of second outer reinforcement beads 153 may interconnect the aforementioned plurality of first outer reinforcement beads 151. Accordingly, the coupling strength between the reinforcement structures of the diaphragm 100 of the present disclosure can be improved, thereby maximizing the stress dispersion effect and enhancing the durability of the diaphragm 100.

In an exemplary embodiment, the plurality of second outer reinforcement beads 153 may be integrally formed with the plurality of first outer reinforcement beads 151 and may be provided using substantially the same material as that of the plurality of first outer reinforcement beads 151.

In addition, the diaphragm 100 of the present disclosure may include a plurality of second inner reinforcement beads 173 that are provided on an inner surface of the separation boundary portion 110 and extend in a circumferential direction from a center of the separation boundary portion 110 so as to spatially overlap the plurality of second outer reinforcement beads 153.

In an exemplary embodiment, the plurality of second inner reinforcement beads 173 may be provided in circular shapes of different sizes surrounding the center of the separation boundary portion 110. For example, as illustrated in FIG. 3, when the plurality of second inner reinforcement beads 173 are provided as three second inner reinforcement beads, the three second inner reinforcement beads 173a to 173c may be provided as three circles of different sizes surrounding the center of the separation boundary portion 110. However, the number and arrangement of the plurality of second inner reinforcement beads 173 are not limited thereto.

Hereinafter, redundant descriptions between the plurality of second inner reinforcement beads 173 and the plurality of second outer reinforcement beads 153 will be omitted, and the differences therebetween will be primarily described.

In an exemplary embodiment, the plurality of second inner reinforcement beads 173 and the plurality of second outer reinforcement beads 153 may be spatially overlapped. In addition, the plurality of second inner reinforcement beads 173 and the plurality of second outer reinforcement beads 153 may be provided in substantially similar sizes and shapes. This overlapping structure may maximize the coupling effect between the reinforcement beads formed on the inner surface and the outer surface of the separation boundary portion 110, thereby further enhancing the structural stability of the diaphragm 100.

Due to the overlapping structure, the diaphragm 100 may be designed such that the protrusion length of the second outer reinforcement beads 153 protruding from the surface of the separation boundary portion 110 is reduced. This design may minimize the effect on fluid flow inside the tank and further alleviate stress concentration that may occur in the diaphragm 100, thereby improving its durability.

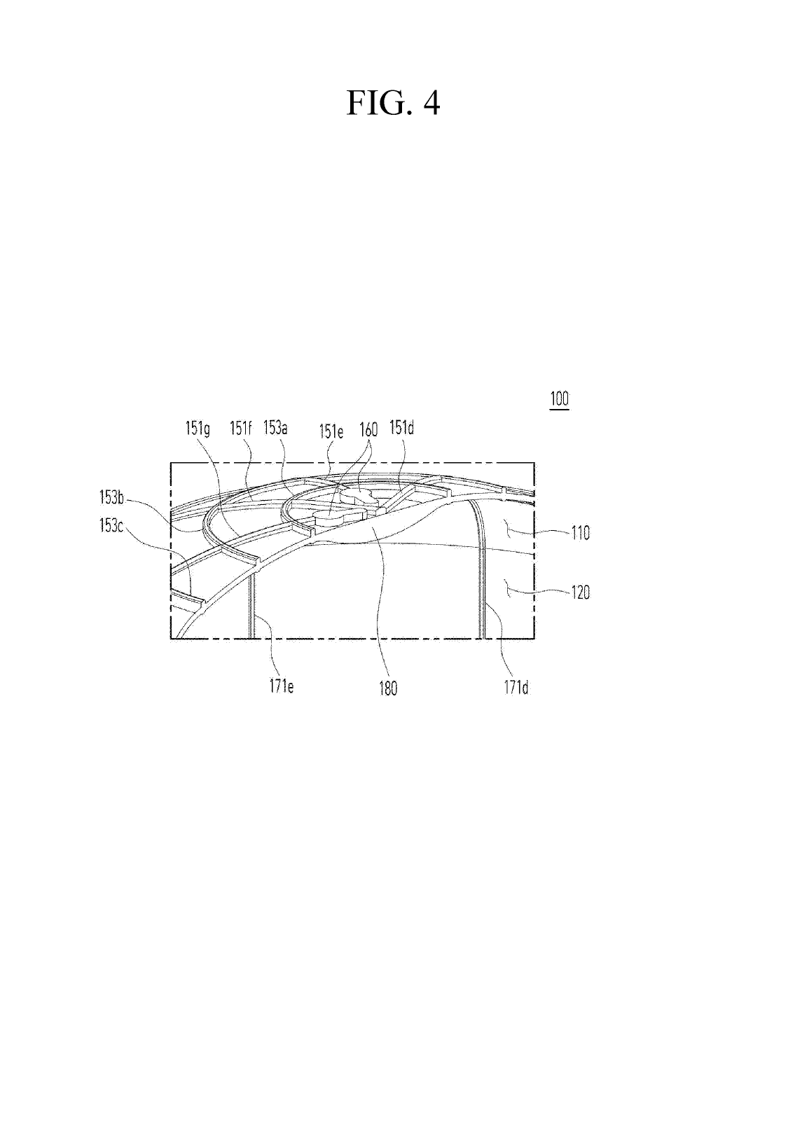

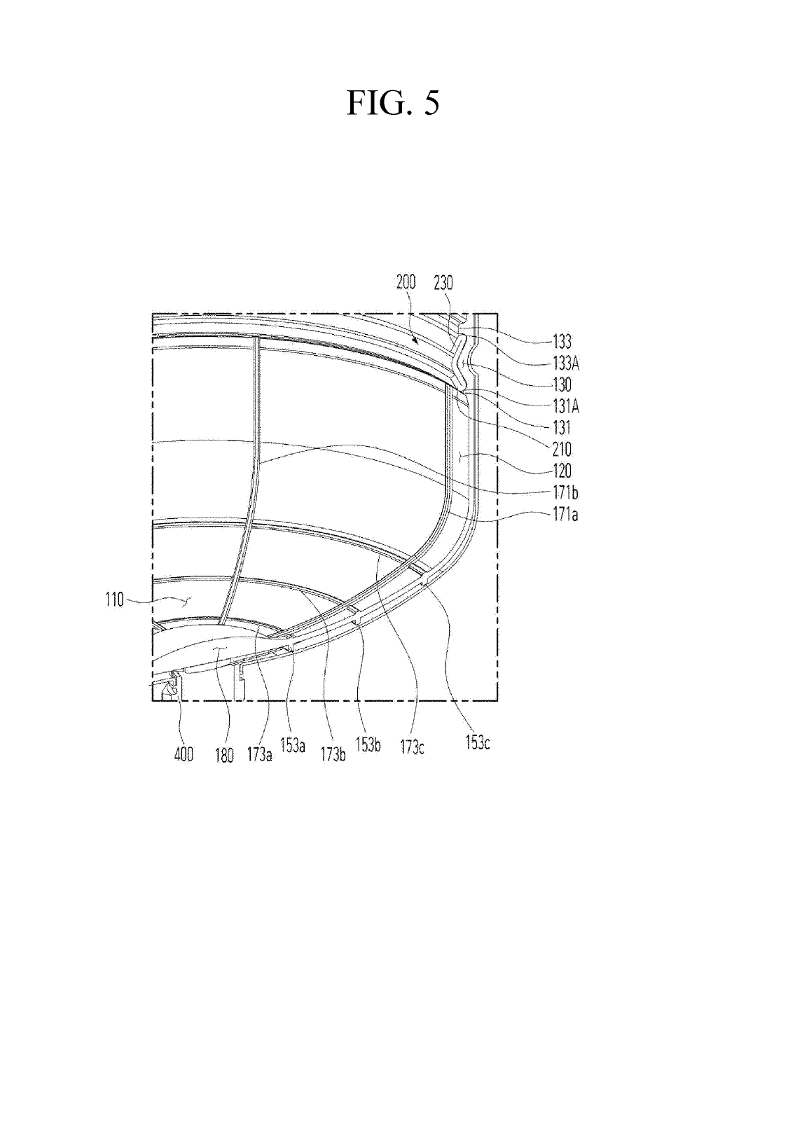

FIG. 4 is a sectional view showing a cut portion of the diaphragm 100 according to an exemplary embodiment of the present disclosure. FIG. 5 is a view showing a portion of the diaphragm 100 installed in a tank according to an exemplary embodiment of the present disclosure.

Referring to FIGS. 4 and 5 together, the diaphragm 100 of the present disclosure may include a curved reinforcement portion 180 that protrudes from an inner surface of the separation boundary portion 110 and has a thickness that gradually increases toward the center (i.e., the thickness gradually decreases toward the edge).

In the diaphragm 100, the greatest force is typically applied to the central portion of the separation boundary portion 110, and due to repeated pressure fluctuations, this central portion is most vulnerable to physical damage.

To prevent this, the diaphragm 100 of the present disclosure may include a curved reinforcement portion 180 having an elliptical curved surface provided on the inner surface of the separation boundary portion 110. The curved reinforcement portion 180 may enhance the rigidity of the separation boundary portion 110 and effectively distribute stress concentration caused by pressure variations, thereby improving the durability of the diaphragm 100.

In an exemplary embodiment, the curved reinforcement portion 180 may be integrally connected to the first inner reinforcement beads 171, thereby uniformly distributing force across the entire surface of the separation boundary portion 110.

In addition, the curved reinforcement portion 180 may be provided in an elliptical curved shape in which the thickness decreases toward the edge, so that deformation of the separation boundary portion 110 of the diaphragm 100 based on pressure changes can occur more naturally. Furthermore, since the curved reinforcement portion 180 may be formed in an elliptical curved shape, fluid may flow smoothly along the curved surface, thereby minimizing flow imbalance caused by fluid resistance.

The diaphragm 100 of the present disclosure may also include a plurality of spacing adjustment portions 160 that protrude from the outer surface of the separation boundary portion 110 and are symmetrically arranged with respect to the center of the separation boundary portion 110.

The plurality of spacing adjustment portions 160 may be provided to maintain a gap space between the diaphragm 100 and the tank 300, thereby ensuring free movement of the diaphragm 100 and preventing a sticking phenomenon.

In an exemplary embodiment, the plurality of spacing adjustment portions 160 may include an undercut on a side surface in order to facilitate release from the mold after molding of the diaphragm 100 is completed. For example, the plurality of spacing adjustment portions 160 may have a groove on the side surface. Due to this undercut structure, the diaphragm 100 of the present disclosure can be smoothly separated from the mold.

In an exemplary embodiment, some of the plurality of spacing adjustment portions 160 may be integrally connected to some of the plurality of first outer reinforcement beads 151 (e.g., 151a, 151c, 151e, and 151g). In addition, the other beads among the plurality of first outer reinforcement beads 151 (e.g., 151b, 151d, 151f, and 151h) may extend in a radial direction between adjacent spacing adjustment portions 160.

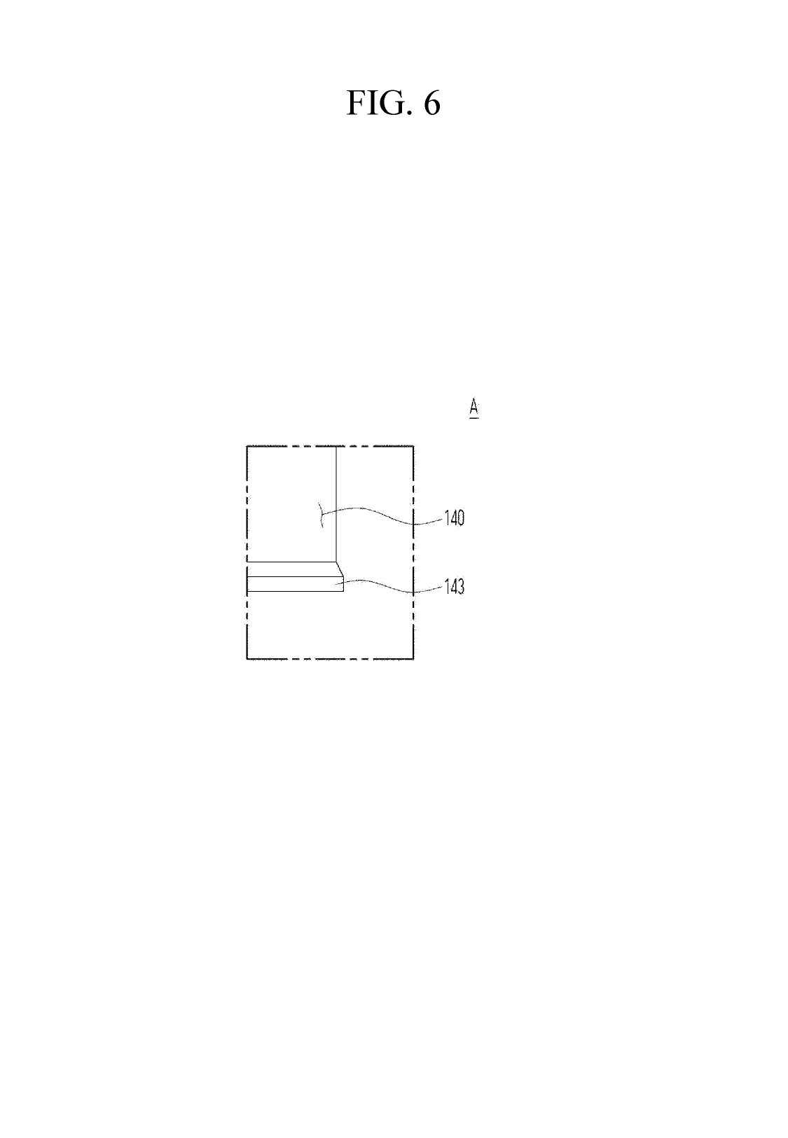

FIG. 6 is an enlarged view of a region marked as A in FIG. 1.

Referring to FIG. 6, the locking portion 140 of the diaphragm 100 of the present disclosure may include a locking protrusion 143 formed on an outer surface of the diaphragm 100.

Since the diaphragm 100 of the present disclosure may include the locking protrusion 143, the diaphragm 100 can be firmly coupled to the tank. Specifically, by including the locking protrusion 143, the fixing portion 130 and the locking portion 140 of the diaphragm 100 can be securely coupled to an inner surface of the tank, while the separation boundary portion 110 and the connection portion 120 may move freely inside the tank.

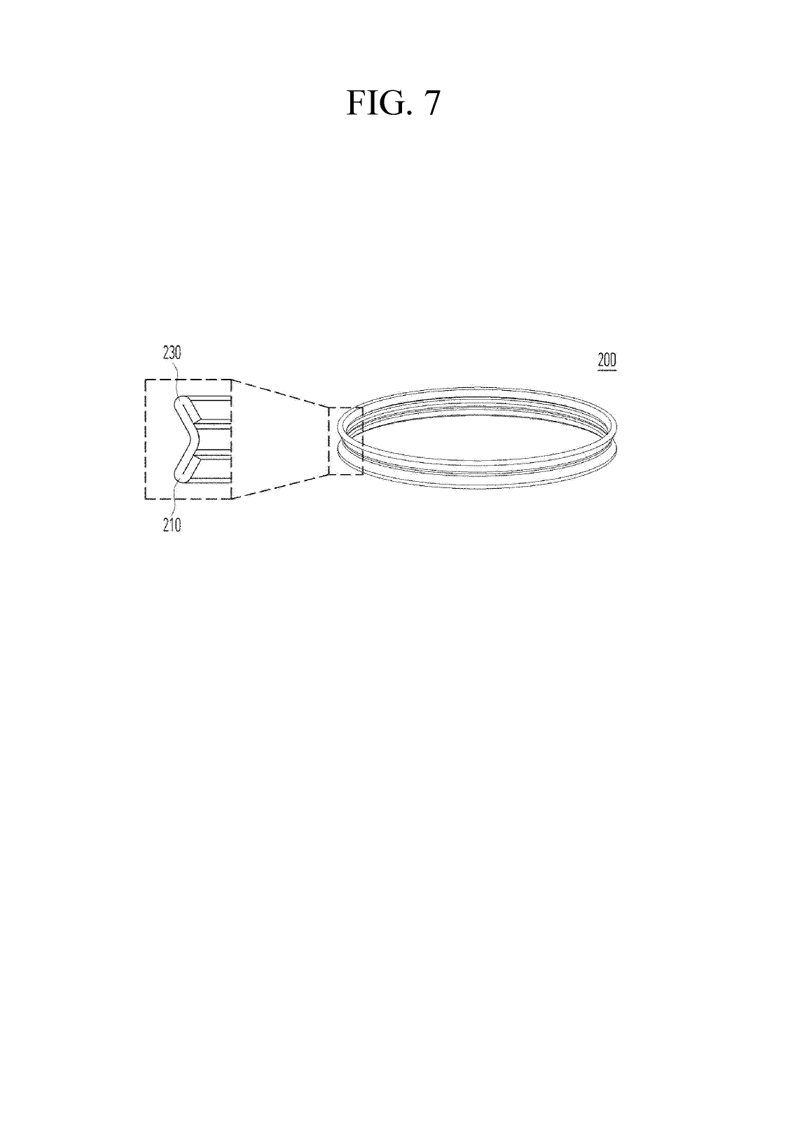

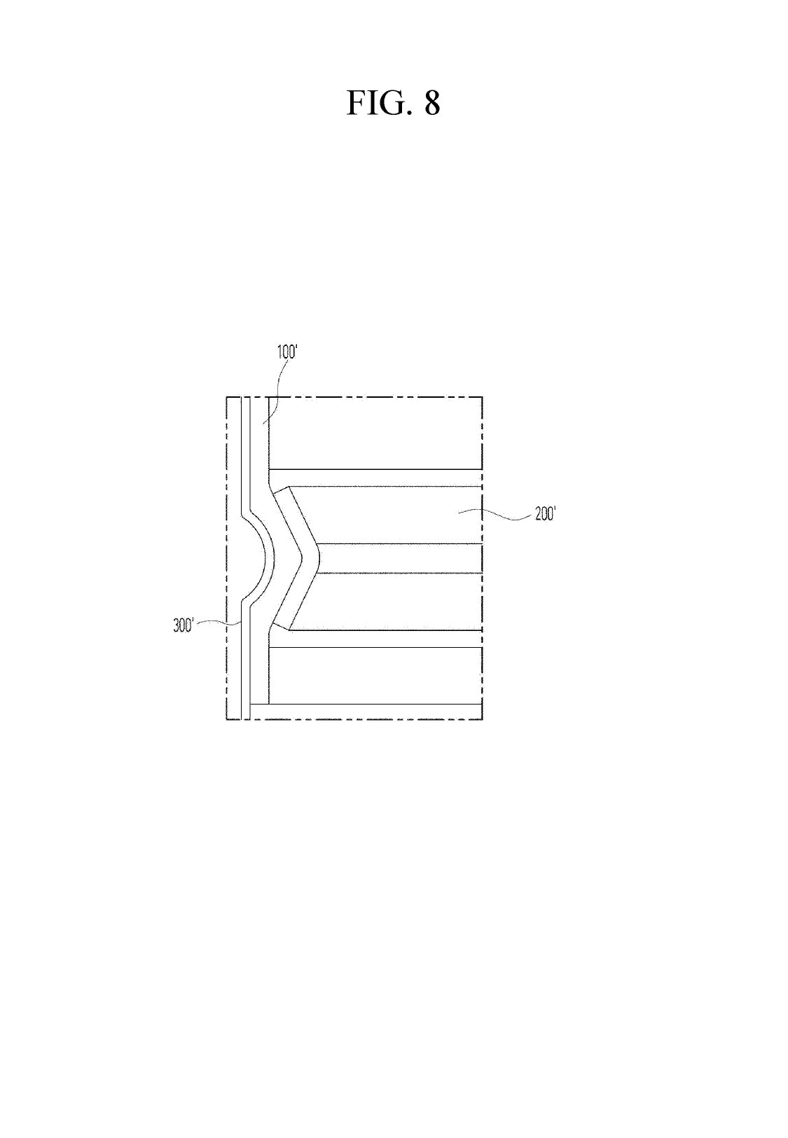

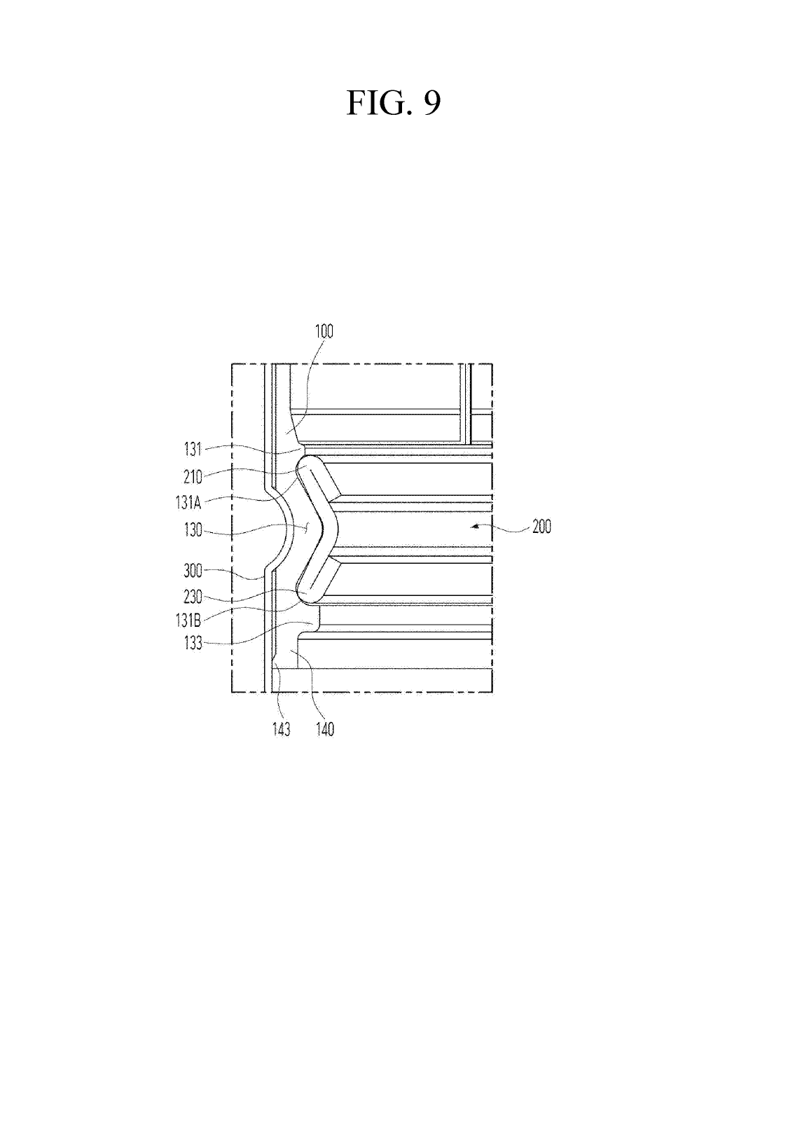

FIG. 7 is a view showing a fixing ring 200 according to an exemplary embodiment of the present disclosure. FIG. 8 is a view showing a coupling relationship between a diaphragm 100′ and a fixing ring 200′ according to a comparative example. FIG. 9 is a view showing a coupling relationship between a diaphragm 100 and a fixing ring 200 according to an exemplary embodiment of the present disclosure.

Referring to FIG. 7, the fixing ring 200 of the present disclosure may be provided inside the diaphragm 100 and may be configured to press the fixing portion 130 of the diaphragm 100 outward to fix the diaphragm 100 to the tank.

In an exemplary embodiment, a cross-section of the fixing ring 200 may be bent inward toward the inside of the diaphragm 100. For example, the cross-section of the fixing ring 200 may have a ‘V’ or ‘U’ shape that is rotated 90 degrees counterclockwise.

In an exemplary embodiment, the fixing ring 200 may include a first fixing portion 210, which is in contact with a first support protrusion 131 of the fixing portion 130 (described below) and has an edge provided in a curved shape. In addition, the fixing ring 200 may include a second fixing portion 230, which is in contact with a second support protrusion 133 of the fixing portion 130 (described below) and has an edge provided in a curved shape.

Referring to FIG. 8, an edge portion of the fixing ring 200′ according to the comparative example may be provided as a flat surface rather than a curved surface, and thus the edge portion may be sharp. Accordingly, a portion of the diaphragm 100′ that comes into contact with the fixing ring 200′ may be at risk of physical damage due to the edge of the fixing ring 200′.

In addition, since the diaphragm 100′ according to the comparative example may not support the fixing ring 200′ in the vertical direction, the coupling between the diaphragm 100′ and the fixing ring 200′ may become weakened due to frequent movement of the diaphragm 100′. As a result, the diaphragm 100′ may become detached from the fixing ring 200′ in the vertical direction.

Furthermore, in the diaphragm 100′ according to the comparative example, a side portion of the diaphragm 100′ may come into contact with an inner surface of the tank 300′ over a relatively large area, and as a result, a sticking phenomenon may occur between the diaphragm 100′ and the tank 300′. This sticking phenomenon may restrict the free movement of the diaphragm 100′, and over long-term use, may lead to performance degradation and difficulty in maintenance.

Referring to FIG. 9, the fixing portion 130 of the diaphragm 100 of the present disclosure may support a first fixing portion 210 of the fixing ring 200 at a first support region that is relatively close to the connection portion 120. The fixing portion 130 may also include a first fixing groove 131A having a concave shape for receiving the first fixing portion 210 of the fixing ring 200.

In an exemplary embodiment, the fixing portion 130 may include a first support protrusion 131 that protrudes inward from the first support region toward the inside of the diaphragm 100 and supports at least a portion of the fixing ring 200. The first support protrusion 131 may reinforce the coupling between the diaphragm 100 and the fixing ring 200, thereby preventing the diaphragm 100 from becoming detached from the fixing ring 200.

The fixing portion 130 of the diaphragm 100 of the present disclosure may support a second fixing portion 230 of the fixing ring 200 at a second support region that is relatively close to the locking portion 140. The fixing portion 130 may also include a second fixing groove 133A having a concave shape for receiving the second fixing portion 230 of the fixing ring 200.

Since the first fixing portion 210 and the second fixing portion 230 of the fixing ring 200 of the present disclosure may have a curved shape, and the diaphragm 100 of the present disclosure may include concave shaped first and second fixing grooves 131A and 133B for receiving the first and second fixing portions 210 and 230, physical damage to the diaphragm 100 caused by the fixing ring 200 can be prevented.

In an exemplary embodiment, the fixing portion 130 may include a second support protrusion 133 that protrudes inward from the second support region toward the inside of the diaphragm 100 and supports at least a portion of the fixing ring 200. The second support protrusion 133 may reinforce the coupling between the diaphragm 100 and the fixing ring 200, thereby preventing the diaphragm 100 from becoming detached from the fixing ring 200.

The separation boundary portion 110 and the connection portion 120, which are provided on one side of the fixing portion 130 of the diaphragm 100, preferably remain free to move in response to pressure variations inside the tank, whereas the locking portion 140, which is provided on the other side of the fixing portion 130, preferably remains restricted in movement under such pressure variations.

To achieve this, a protrusion length of the second support protrusion 133 may be greater than a protrusion length of the first support protrusion 131. Accordingly, the separation boundary portion 110 and the connection portion 120 of the diaphragm 100 may move freely in response to pressure variations inside the tank due to the relatively short protrusion length of the first support protrusion 131, while the locking portion 140 may remain restricted in movement due to the relatively long protrusion length of the second support protrusion 133. This structure of the diaphragm 100 may improve both operational efficiency and coupling strength.

In addition, since the locking portion 140 of the diaphragm 100 of the present disclosure may include a locking protrusion 143, the fixing portion 130 and the locking portion 140 of the diaphragm 100 may be firmly coupled to the inner surface of the tank.

FIG. 10 is a view showing a diaphragm assembly 10 coupled to a tank 300 according to an exemplary embodiment of the present disclosure.

Referring to FIG. 10, the diaphragm assembly 10 of the present disclosure may include a diaphragm 100 and a fixing ring 200 configured to couple the diaphragm 100 to the tank 300.

The technical features of the diaphragm 100 and the fixing ring 200 of the present disclosure are the same as those described above with reference to FIGS. 1 to 9, and thus a detailed explanation thereof is omitted.

An air injection valve 500 may be provided at one portion of the tank 300, and a liquid connection valve 400 may be provided at another portion. For example, the air injection valve 500 may be used to fill the tank 300 with air and then sealed with a separate sealing member. In addition, repeated expansion and contraction of liquid volume may occur due to changes in the internal liquid temperature of the tank 300, which may lead to pressure fluctuations inside the tank.

The diaphragm 100 of the present disclosure may move in a vertical direction inside the tank 300 to maintain internal pressure. For example, as shown by the dotted line B in FIG. 10, the diaphragm 100 may move in response to internal pressure variations of the tank 300 and thereby absorb such pressure fluctuations.

As described above, exemplary embodiments have been disclosed in the drawings and the specification. Although specific terms have been used to describe the embodiments, such terms are merely intended to describe the technical features of the present disclosure and are not intended to limit the scope of the present disclosure as set forth in the claims. It will be understood by those skilled in the art that various modifications and equivalent embodiments can be made without departing from the spirit of the present disclosure. Therefore, the true technical scope of the present disclosure should be defined by the claims.

What is claimed is:

1. A diaphragm assembly for regulating internal pressure of a tank, comprising:
a diaphragm disposed inside the tank, the diaphragm comprising:
a separation boundary portion that separates liquid and gas inside the tank;
a connection portion extending in one direction from the separation boundary portion;
a fixing portion extending from the connection portion and bent toward an inside of the diaphragm to have a concave shape; and
a locking portion extending from the fixing portion, at least a portion of the locking portion being engaged with an inner surface of the tank; and
a fixing ring provided inside the diaphragm and configured to press the fixing portion to fix the diaphragm to the tank,
wherein the diaphragm comprises:
a plurality of first outer reinforcement beads provided on an outer surface of the separation boundary portion and extending in a radial direction from a center of the separation boundary portion; and
a plurality of first inner reinforcement beads provided on an inner surface of the separation boundary portion and extending in a radial direction from the center of the separation boundary portion so as to spatially overlap the plurality of first outer reinforcement beads.

2. The diaphragm assembly of claim 1,
wherein the diaphragm further comprises:
a plurality of second outer reinforcement beads provided on the outer surface of the separation boundary portion and extending in a circumferential direction surrounding the center of the separation boundary portion; and
a plurality of second inner reinforcement beads provided on the inner surface of the separation boundary portion and extending in a circumferential direction surrounding the center of the separation boundary portion so as to spatially overlap the plurality of second outer reinforcement beads.

3. The diaphragm assembly of claim 1,
wherein the plurality of first outer reinforcement beads and the plurality of first inner reinforcement beads extend to the connection portion of the diaphragm.

4. The diaphragm assembly of claim 1,
wherein the diaphragm further comprises a curved reinforcement portion that protrudes from the inner surface of the separation boundary portion and has a thickness that gradually increases toward the center.

5. The diaphragm assembly of claim 4,
wherein the curved reinforcement portion is integrally connected to the plurality of first inner reinforcement beads and has a thickness greater than a thickness of the plurality of first inner reinforcement beads.

6. The diaphragm assembly of claim 1,
wherein the diaphragm further comprises:
a plurality of spacing adjustment portions that protrude from the outer surface of the separation boundary portion to form a gap space between a portion of the diaphragm and the tank, and are symmetrically disposed with respect to the center of the separation boundary portion,
wherein some of the plurality of first outer reinforcement beads are connected to the plurality of spacing adjustment portions, and
wherein the other beads of the plurality of first outer reinforcement beads extend between adjacent spacing adjustment portions.

7. The diaphragm assembly of claim 1,
wherein the diaphragm further comprises:
a first support protrusion that protrudes toward an inside of the diaphragm from a first support region of the fixing portion, which is relatively close to the connection portion, and supports at least a portion of the fixing ring; and
a second support protrusion that protrudes toward an inside of the diaphragm from a second support region of the fixing portion, which is relatively close to the locking portion, and supports at least a portion of the fixing ring.

8. The diaphragm assembly of claim 7,
wherein a protrusion length of the second support protrusion is greater than a protrusion length of the first support protrusion.

9. The diaphragm assembly of claim 7,
wherein the fixing ring comprises:
a first fixing portion that is in contact with the first support protrusion and has a curved shape; and
a second fixing portion that is in contact with the second support protrusion and has a curved shape,
wherein the fixing portion of the diaphragm comprises:
a first fixing groove that has a concave shape for receiving the first fixing portion; and
a second fixing groove that has a concave shape for receiving the second fixing portion.

10. A diaphragm configured to regulate internal pressure of a tank and comprising a separation boundary portion that separates liquid and gas inside the tank, the diaphragm comprising:
a plurality of first outer reinforcement beads provided on an outer surface of the separation boundary portion and extending in a radial direction from a center of the separation boundary portion;
a plurality of first inner reinforcement beads provided on an inner surface of the separation boundary portion and extending in a radial direction from a center of the separation boundary portion so as to spatially overlap the plurality of first outer reinforcement beads;
a plurality of second outer reinforcement beads provided on the outer surface of the separation boundary portion and extending in a circumferential direction surrounding the center of the separation boundary portion;
a plurality of second inner reinforcement beads provided on the inner surface of the separation boundary portion and extending in a circumferential direction surrounding the center so as to spatially overlap the plurality of second outer reinforcement beads; and
a curved reinforcement portion that protrudes from the inner surface of the separation boundary portion, has a thickness that gradually increases toward the center, and is integrally connected to the plurality of first inner reinforcement beads.
